(19) United States
(12) Patent Application Publication
(10) Pub. No.: US 2015/0171469 A1
(43) Pub. Date: Jun. 18, 2015

(54) ADDITIVES WITH IONOMER ARTICLES, METHODS FOR MAKING AND METHODS FOR USING

(71) Applicant: E.I. DU PONT DE NEMOURS AND COMPANY, Wilmington, DE (US)

(72) Inventors: Kostantinos Kourtakis, Media, PA (US); Gerard Joseph Grier, Wilmington, DE (US)

(21) Appl. No.: 14/409,263

(22) PCT Filed: Apr. 4, 2013
(86) PCT No.: PCT/US2013/035218

§ 371 Date: Dec. 18, 2014

Related U.S. Application Data
(60) Provisional application No. 61/661,490, filed on Jun. 19, 2012.

(51) Int. Cl. H01M 10/0567; H01M 2/16; H01M 10/052

(52) U.S. Cl. CPC H01M 10/0567; H01M 10/052; H01M 2/1653; H01M 2/162; H01M 2300/0025

(57) ABSTRACT

There are cells comprising a sulfur-containing first electrode. The cells also comprise a lithium-containing second electrode associated with a total amount of electrode lithium, including electrochemically utilized electrode lithium. The cells also includes a circuit coupling the first electrode with the second electrode, an article comprising an ionomer and an electrolyte medium comprising at least one additive selected from one or more of the groups consisting of nitrogen-containing additives, sulfur-containing additives, and organic peroxide additives. There are also associated methods of making and methods of using the cells.

### CROSS-REFERENCE TO RELATED APPLICATIONS

This application claims priority to and the benefit of the filing date of U.S. Provisional Application Nos. 61/661490, filed on Jun. 19, 2012, the entirety of which is herein incorporated by reference.

### BACKGROUND

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A common limitation of previously-developed Li—S cells and batteries is capacity degradation or capacity “fade”. Capacity fade is associated with coulombic efficiency, the fraction or percentage of the electrical charge stored by charging that is recoverable during discharge. It is generally believed that capacity fade and coulombic efficiency are due, in part, to sulfur loss through the formation of certain soluble sulfur compounds which “shuttle” between electrodes in a Li—S cell and react to deposit on the surface of a negative electrode in a Li—S cell. It is believed that these deposited sulfides can obstruct and otherwise foul the surface of the negative electrode and may also result in sulfur loss from the total electroactive sulfur in the cell.

The formation of anode-deposited sulfur compounds involves complex chemistry which is not completely understood.

In addition, low coulombic efficiency is another common limitation of Li—S cells and batteries. A low coulombic efficiency can be accompanied by a high self-discharge rate. It is believed that low coulombic efficiency is also a consequence, in part, of the formation of the soluble sulfur compounds which shuttle between electrodes during charge and discharge processes in a Li—S cell.

Li—S cells and batteries are desirable based on the high theoretical capacities and high theoretical energy densities of the electroactive sulfur in their positive electrodes. However, attaining the full theoretical capacities and energy densities remains elusive. Furthermore, as mentioned above, the sulfide shuttling phenomena present in Li—S cells (i.e., the movement of polysulfides between the electrodes) can result in relatively low coulombic efficiencies for these electrochemical cells; and this is typically accompanied by undesirably high self-discharge rates.

At least one electrode in a cell of a Li—S battery contains a significant amount of lithium. Commonly an anode is made with lithium metal. Lithium metal has a high specific volume, thus the anode is often a significant cell component in terms of the impact it has on the size and/or weight related metrics of the cell and cost of the materials used to make the electrode. Conventionally, a Li—S cell is designed to include an excess amount of lithium metal in the anode in order to provide a surplus anode surface for providing and/or receiving lithium ions which may be electrochemically utilized during the cycling phases of the cell.

The excess lithium metal is commonly incorporated into the anode due to soluble sulfur compounds which react to deposit on parts of the anode surface during the cycling phases of the cell. However, the excess lithium in the anode occupies a volume of the Li—S cell and adds to the cell's mass. Thus the excess lithium metal in the anode decreases the energy metrics of the cell, including its energy density and specific energy. The excess lithium metal in the anode also impacts negatively on portability and related cell design considerations. However, attaining improvements to the energy metrics of Li—S batteries and cells remains elusive due at least in part to the limitations associated with the amounts of lithium utilized in the electrode materials of previously-developed Li—S batteries and cells.

Given the foregoing, what are needed are Li—S cells and batteries without the above-identified limitations of previously-developed Li—S cells and batteries.

### BRIEF SUMMARY

This summary is provided to introduce a selection of concepts. These concepts are further described below in the detailed description in conjunction with the accompanying drawings. This summary is not intended to identify key features or essential features of the claimed subject matter, nor is this summary intended as an aid in determining the scope of the claimed subject matter.

The present disclosure hereof meets the above-identified needs by providing Li—S cells incorporating at least one ionomer article and at least one additive in the electrolyte medium of the cells. The additive may be selected from one or more of the groups consisting of nitrogen-containing additives, sulfur-containing additives and organic peroxide additives. The ionomer article may be described, generally, as an ionomer membrane or film incorporating one or more types of ion-containing polymer materials having ions incorporated into the polymer itself, such as ionomers, situated within at least a part of the ionomer article. The ionomer article may form part or all of an ionomer-containing lithium transport separator.

In addition to ion-containing polymer materials, an ionomer article may also incorporate other polymeric materials that do not have ion groups incorporated into the polymers. These other polymeric materials may be incorporated into an ionomer article in various ways, such as in a combination by blending the other polymeric material with an ionomer and incorporating the blend into a localized region. Non-ion-containing polymer materials may be selected and incorporated into various locations in an ionomer article, such as a membrane, for the physical and/or chemical properties which these materials impart to the membrane.

The ionomer articles and additives provide Li—S cells and batteries with surprisingly high coulombic efficiencies and very high ratios of discharge to charge capacity and without the above-identified limitations of previously-developed Li—S cells and batteries. In some embodiments, the ionomer articles and additives may also provide Li—S cells and batteries with high maximum discharge capacities. In other embodiments, the Li—S cells comprising the ionomer articles and additives have a total amount of electrode lithium which includes a high proportion of electrochemically utilized electrode lithium. While not being bound by any particular theories, it is believed that the ionomer in the ionomer articles suppress the shuttling of soluble sulfur compounds through a Li—S cell's electrolyte medium, thus inhibiting their arrival at a negative electrode in the Li—S cell. In addition, it is also believed that the additives suppress the formation of sulfides or other deposits on the negative electrode. Thus, the ionomer articles and additives reduce capacity fade through sulfur loss in the cell and/or through self-discharge of the cell.

These and other objects are accomplished through Li—S cells comprising ionomer articles and additives, methods for making and methods for using such in accordance with the principles of the disclosure hereof.

According to a first principle of the disclosure hereof, there is a cell comprising a sulfur-containing first electrode and a lithium-containing second electrode associated with a total amount of electrode lithium, including electrochemically utilized electrode lithium. The cell also comprises a circuit coupling the first electrode and the second electrode, an article comprising an ionomer and an electrolyte medium comprising at least one additive selected from one or more of the groups consisting of nitrogen-containing additives, sulfur-containing additives and organic peroxide additives.

According to a second principle of the disclosure hereof, there is a method for making a cell. The method comprises providing an article comprising an ionomer and fabricating the cell by combining the article with other components to form the cell. The other components include a sulfur-containing first electrode, a lithium-containing second electrode and a circuit coupling the first electrode and the second electrode. The components also include an electrolyte medium comprising at least one additive selected from one or more of the groups consisting of nitrogen-containing additives, sulfur-containing additives and organic peroxide additives.

According to a third principle of the disclosure hereof, there is a method for using a cell. The method comprises at least one step from the plurality of steps comprising converting chemical energy stored in the cell into electrical energy and converting electrical energy into chemical energy stored in the cell. The cell comprises a sulfur-containing first electrode and a lithium-containing second electrode associated with a total amount of electrode lithium, including electrochemically utilized electrode lithium. The cell also comprises a circuit coupling the first electrode and the second electrode, an article comprising an ionomer and an electrolyte medium comprising at least one additive selected from one or more of the groups consisting of nitrogen-containing additives, sulfur-containing additives and organic peroxide additives.

Examples of the ionomer articles, the additives and Li—S cells comprising these elements are further described below in the detailed description and with respect to the drawings.

The above summary is not intended to describe each embodiment or every implementation of the present disclosure hereof. Further features, their nature and various advantages are described in the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the figures in the drawings highlight the aspects, methodology, functionality and advantages of the present invention, and are presented for example purposes only. The present invention is sufficiently flexible such that it may be implemented in ways other than shown in the accompanying figures.

FIG. 1 is a two-dimensional perspective of a Li—S cell incorporating several ionomer articles and additive in an electrolyte medium, according to an example;

FIG. 2 is a context diagram illustrating properties of a Li—S battery including a Li—S cell incorporating an ionomer article and additive in an electrolyte medium, according to an example;

FIG. 3 is a two-dimensional perspective of a Li—S coin cell incorporating an ionomer article and additive in an electrolyte medium, according to an example; and

FIG. 4 is a graph of data demonstrating the electrochemical performances of various Li—S cells, according to various examples and comparative examples.

### DETAILED DESCRIPTION

The inventions hereof are useful for certain energy storage applications, and has been found to be particularly advantageous for high maximum discharge capacity batteries which operate with high coulombic efficiency utilizing electrochemical voltaic cells which derive electrical energy from chemical reactions involving sulfur compounds. While the present invention is not necessarily limited to such applications, various aspects of the invention are appreciated through a discussion of various examples using this context.

For simplicity and illustrative purposes, the inventions hereof are is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of these embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and/or their equivalents. The significance of the examples may be better understood by comparing the results obtained therefrom with potential results which may be obtained from tests or trials that may be, or may have been, designed to serve as controlled experiments and to provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

The meaning of abbreviations and certain terms used herein is as follows: “A” means angstrom(s), “μm” means micrometer(s) or micron(s), “g” means gram(s), “mg” means milligram(s), “μg” means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in 1/x hours, “SOC” means state of charge, “SEI” means solid electrolyte interface formed on the surface of an electrode material, “kPa” means kilopascal(s), “rpm” means revolutions per minute, and “psi” means pounds per square inch.

The term “maximum discharge capacity” is the maximum milliamp hour(s) per gram of a positive electrode in a Li—S cell at the beginning of a discharge phase (i.e., maximum charge capacity on discharge), “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., Vp) is the sum of the volumes of all the pores in one gram of a substance and may be expressed as cc/g, “porosity” (i.e., “void fraction”) is either the fraction (0-1) or the percentage (0-100%) expressed by the ratio: (volume of voids in a substance)/(total volume of the substance).

As used herein and unless otherwise stated the term “cathode” is used to identify a positive electrode and “anode” to identify the negative electrode of a battery or cell. The term “battery” is used to denote a collection of one or more cells arranged to provide electrical energy. The cells of a battery can be arranged in various configurations (e.g., series, parallel and combinations thereof).

The term “sulfur compound” as used herein refers to any compound that includes at least one sulfur atom, such as elemental sulfur and other sulfur compounds, such as lithiated sulfur compounds including disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al., J. Electrochem. Soc., Vol. 144, No. 6, pp. L170-L172 (June 1997), which is incorporated herein by reference in its entirety.

The term “ionomer”, as used herein, refers to any polymer including an ionized functional group (e.g., sulfonic acid, phosphonic acid, phosphoric acid or carboxylic acid, such as acrylic or methacrylic acid (i.e., “(meth)acrylic acid”) in which the acid group is neutralized with a base including an alkali metal, such as lithium, to form an ionized functionality, such as lithium methacrylate). The term “ionomer” may also refer to a combination of ion-containing polymer materials in which the ions are incorporated into the polymer itself, such as an ionomer blend, unless a use of the term indicates otherwise, such as through the context within which it is used. The term “halogen ionomer”, as used herein, refers to any ionomer including at least one halogen atom (i.e., fluorine (F), chlorine (Cl), bromine (Br), iodine (I), and astatine (At)) incorporated by a covalent bond into a site (e.g., the polymer backbone or branching) on the ionomer. The term “hydrocarbon ionomer”, as used herein, refers to any ionomer not including any halogen atoms incorporated by a covalent bond into a site (e.g., the polymer backbone or branching) on the ionomer.

The term “lithium transport separator” as used herein refers to a selective separator, capable of transporting lithium ions, while moderating other species, such as polysulfides. A lithium transport separator may include an ionomer article, such as an ionomer membrane, which may be formed in different ways and contains at least one ionomer material.

According to the principles of the inventions hereof, as demonstrated in the following examples and embodiments, there are Li—S cells incorporating ionomer-containing articles, such as a lithium transport separator comprising an ionomer membrane. An ionomer membrane contains at least one type of ionomer and may also contain one or more other materials, such as a second ionomer and/or a polymer which is not an ion-containing polymer, such as a polyolefin. An ionomer membrane may be associated with various elements in a Li—S cell, such as attached to and/or functioning as part, or all, of a lithium transport separator situated in an electrolyte medium of the cell. According to various embodiments, different types of ionomers may be used in forming an ionomer membrane.

According to an example, an ionomer may be halogen ionomer, such as a fluorinated ionomer containing sulfonate groups based on ionized sulfonic acid (e.g., fluorosulfonic acid (i.e., FSA) ionomer). According to another example, an ionomer may be a hydrocarbon ionomer containing (meth)acrylate groups based on ionized (meth)acrylic acid. In still another example, a combination of hydrocarbon ionomer(s) and halogen ionomer(s) may be incorporated in an ionomer membrane. The combination of ionomers may comprise separate constituent ionomers which are located in different parts of an ionomer membrane. In the alternative, a combination of ionomers may comprise a blend of constituent ionomers which may be incorporated together into one or more parts of an ionomer membrane.

Examples of halogen ionomers which may be incorporated into an ionomer membrane include Nafion® (i.e., “NAFION”) and its derivatives. NAFION is a sulfonate-containing tetrafluoroethylene based fluoro-copolymer with fluorine located along the polymer backbone and branching. Other examples of halogen ionomers are perfluorocarboxylate ionomers, such as Flemion®, which contains both sulfonate and carboxylate groups. Fluorinated sulfonated halogen ionomers may be prepared using fluorinated vinyl monomers. Additional examples of halogen ionomers which may be incorporated in an IC membrane include sulfonated polyacrylamides, polyacrylates, polymethacrylates and sulfonated polystyrene which contain halogen. Other halogen ionomers may also be incorporated as well, or in the alternative, such as ionomers containing halogen and having ionomer functional groups based on neutralized carboxylic acids, phosphonic acids, phosphoric acids and/or other ionomer functional groups. The halogen ionomers always contain one or more halogen atoms, such as in halogen substituents and in halogen-containing substituents. The substituents may contain any species of halogen, such as fluorine as in a FSA ionomer, bromine as in a brominated polyurethane ionomer or another halogen species. The halogen atoms in a halogen ionomer may be located anywhere in the ionomer, such as along the backbone and/or along any branching which may be present.

Examples of hydrocarbon ionomers which may be incorporated into an ionomer membrane include Surlyn® (i.e., “SURLYN”) and derivatives of SURLYN, a copolymer of ethylene and (meth)acrylic acid. Depending upon the commercially available grade of SURLYN that is used, an amount of the ionizable (meth)acrylic acid groups in the SURLYN can be neutralized to their ionic (meth)acrylate salt. Other examples of hydrocarbon ionomers which may be incorporated in an ionomer membrane include sulfonated polyacrylamide and sulfonated polystyrene. Other hydrocarbon ionomers may be incorporated as well or in the alternative, such as ionomers having ionomer functional groups based on neutralized carboxylic acids, phosphonic acids, phosphoric acids and/or other ionomer functional groups.

Different types of copolymers may be incorporated as ionomers (e.g., halogen ionomers, hydrocarbon ionomers, etc.) in an ionomer membrane, such as copolymers with different non-ionic monomers or multiple types of ionic monomers. Other ionomers may be combined in an ionomer membrane, such as ionomers having the same or different ionic functionality, but with otherwise different polymeric structures and/or different non-ionic substituents. As an example, an ionomer may include both acid and alkyl substituents. In another example, an ionomer may include unsaturated branches with or without any functional groups or substituents. The substituent sites on a hydrocarbon ionomer may be located substantially anywhere in a polymer, such as along the backbone and/or along any branching which may be present.

One or more ionomers may be combined with other components to form an ionomer membrane which can be incorporated into a Li—S cell, according to various embodiments. Other configurations are also possible, such as an ionomer membrane incorporating a blend of ionomers in one or more locations of the ionomer membrane.

Furthermore, polymeric materials which are not ion-containing may be used for making part of an ionomer membrane. Examples of classes of suitable polymer materials include, but are not limited to, homopolymers, copolymers and blends of: polyolefins, polyesters, polyamides, polyurethanes, polyethers, polysulfones, vinyl polymers, polystyrenes, polysilanes, fluorinated polymers and variants thereof as described in U.S. Pat. No. 7,965,049 to Kapur et al., which is incorporated herein by reference.

Also according to the principles of the inventions hereof, as demonstrated in the following examples and embodiments, the Li—S cells incorporate at least one additive in an electrolyte medium of the cells. The concentration of the at least one additive in the electrolyte medium may vary significantly. According to one embodiment, the concentration is from about 0.0001 to 5 M, preferably the concentration is from about 0.01 to 1 M, and more preferably the concentration is from about 0.1 to 0.5 M. According to some embodiments the additive may contain a Group 1 or Group 2 metal, such as lithium. The additive may be selected from one or more of the groups consisting of nitrogen-containing additives, sulfur-containing additives and organic peroxide additives.

A nitrogen-containing additive may be selected from one or more of the groups consisting of inorganic nitrates, organic nitrates, inorganic nitrites, organic nitrites, organic nitro compounds, inorganic nitro-compounds, nitramines, isonitramines, nitramids, organic and inorganic nitroso-compounds, salts of nitronium and nitrosonium, nitrone salts and esters, N-oxides, nitrolic acid salts and esters, hydroxylamine and hydroxylamine derivatives.

Preferably, the nitrogen-containing additive may be selected from one or more of the groups consisting of inorganic nitrates, organic nitrates, alkyl nitrates, inorganic nitrites, organic nitrites, alkyl nitrites, organic nitro compounds and inorganic nitro-compounds.

Examples of nitrogen-containing additives include lithium nitrate, potassium nitrate, cesium nitrate, ammonium nitrate, lithium nitrite, potassium nitrite, cesium nitrite, ammonium nitrite, aminoguanidine nitrate, guanidine nitrate, aminoguanidine nitrite and guanidine nitrite. Other nitrogen-containing additives suitable for use herein are described in U.S. Patent Application Publication No. 2008/0193835 to Mikhaylik, which is incorporated by reference herein in its entirety.

A sulfur-containing additive may be selected from one or more of the groups consisting of sulfites, persulfates and hyposulfites. Examples of sulfur-containing additives suitable for use herein include lithium persulfate, sodium persulfate, sodium hyposulfite, zinc hyposulfite, cobalt hyposulfite and ammonium sulfite.

An organic peroxide additive may be selected from one or more of the groups consisting of alkyl hydroperoxides (ROOH), dialkyl peroxides (R¹OOR²), peroxycarboxylic acids (RCOOOH), diacyl peroxides (R¹COOCOR²), R¹COOSO2R²), peroxycarboxylic esters (R¹COOR²) and peroxycarbonated esters (R¹OCOOR²). Examples of organic peroxide additives suitable for use herein include benzoyl peroxide, methylethylketone peroxide and 2-butanone peroxide. Other organic peroxides suitable for use herein are found in Organic Peroxy Compounds, H. Klenk, P. Gotz, R. Siegmeier, W. Mayer, Wiley, 2000, which is incorporated by reference herein.

Examples of the ionomer articles, the additives and Li—S cells comprising these elements are now described with respect to the related drawings and figures.

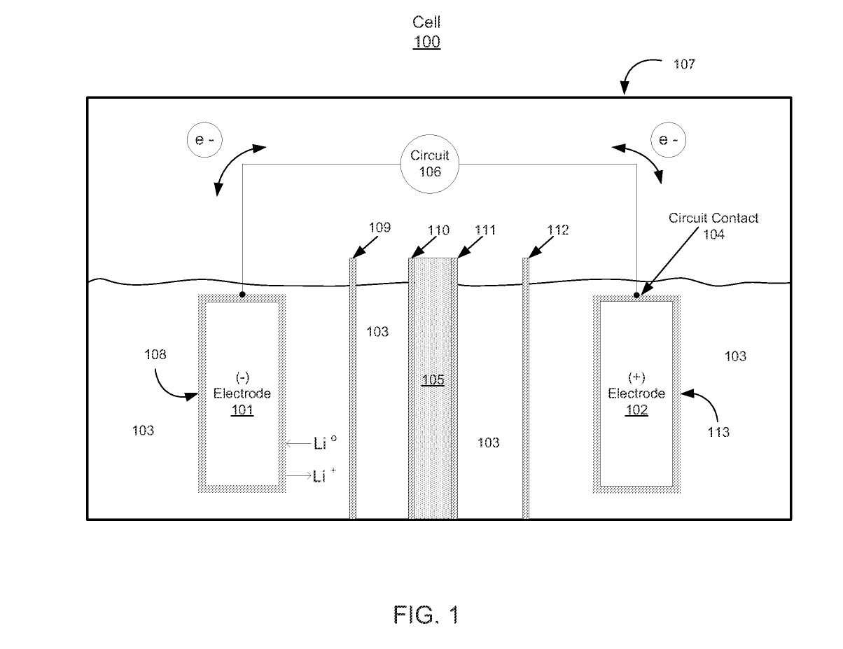

Referring to FIG. 1, depicted is a cell 100, such as a Li—S cell in a Li—S battery. Cell 100 includes a lithium containing negative electrode 101, a sulfur-containing positive electrode 102, a circuit 106 and a lithium transport separator 105. A cell container wall 107 contains the elements in the cell 100 with an electrolyte medium, such as a cell solution comprising solvent and electrolyte. The positive electrode 102 includes a circuit contact 104. The circuit contact 104 provides a conductive conduit through a metallic circuit 106 coupling the negative electrode 101 and the positive electrode 102. The positive electrode 102 is operable in conjunction with the negative electrode 101 to store electrochemical voltaic energy in the cell 100 and to release electrochemical voltaic energy from the cell 100, thus converting chemical and electrical energy from one form to the other, depending upon whether the cell 100 is in the charge phase or the discharge phase.

According to an embodiment, the negative electrode 101 incorporates a total amount of electrode lithium, such as a lithium metal. At least a portion of the electrode lithium is electrochemically utilized in the charge phases and/or the discharge phases of cell 100, plating in and/or out of the negative electrode 101 as depicted in FIG. 1. According to another embodiment, a positive electrode, such as the positive electrode 102, may incorporate a total amount of electrode lithium at least a portion of which is electrochemically utilized in the charge phases and/or the discharge phases of a cell, such as cell 100.

A porous carbon material, such as a carbon powder, having a high surface area and a high pore volume, may be utilized in the making the positive electrode 102. According to an embodiment, a sulfur compound, such as elemental sulfur, lithium sulfide, and combinations of such, may be introduced to the porous regions within the carbon powder to make a carbon-sulfur (C—S) composite which is incorporated into a cathode composition in the positive electrode 102. A polymeric binder may also be incorporated into the cathode composition with the C—S composite in the positive electrode 102. In addition, other materials may be utilized in the positive electrode 102 to host the sulfur compound as an alternative to the carbon powder, such as graphite, graphene and carbon fibers. The structure used to host the sulfur compound in the positive electrode 102 need not be a C—S composite, and the construction of the positive electrode 102 may be varied as desired.

Additive 103 may be dispersed throughout an electrolyte medium in the cell 100, as depicted in FIG. 1. According to other embodiments, the presence of an additive may be localized and/or the concentration of additive may be varied in select volumes of an electrolyte medium in a cell, such as cell 100. The additive 103 may be selected from one or more of the groups consisting of nitrogen-containing additives, sulfur-containing additives and organic peroxide additives.

The lithium transport separator 105 in cell 100 incorporates an ionomer membrane comprising an ionomer, such as a NAFION derivative. When situated in the cell 100, the ionomer membrane within the lithium transport separator 105 may be exposed to an amount of cell solution. The exposed areas of the ionomer membrane appear to function as a barrier to limit the passage of soluble sulfur compounds (e.g., lithium polysulfides) “shuttling” through the cell solution from reaching the negative electrode 101. However, the ionomer membrane in the lithium transport separator 105 still permits the diffusion of lithium ions through at least the NAFION derivative in the ionomer membrane during the charge and discharge phases of the cell 100. The ionomer membrane may also function as a reservoir through adsorption of the lithium polysulfides from the cell solution which is exposed to the ionomer membrane, thus withdrawing these sulfur compounds temporarily from the cell solution.

In addition to the ionomer membrane in the lithium transport separator 105, cell 100 also includes ionomer membranes 108, 109, 110, 111, 112 and 113, all of which comprise at least one ionomer, such as a NAFION derivative.

Ionomer membrane 108 is an anodic-lithium transport separator as it is affixed or in close proximity to a surface of the negative electrode 101. Ionomer membrane 108 comprises at least one ionomer, such as one of the halogen or hydrocarbon ionomers noted above. In an embodiment, ionomer membrane 108 includes a protective layer, separating lithium metal in the negative electrode 101 from the halogen ionomer in the ionomer membrane 108. The protective layer comprises a permeable substance which is substantially inert to lithium metal in the negative electrode 101. Suitable inert substances include porous films containing polypropylene and polyethylene.

According to an embodiment, the ionomer in ionomer membrane 108 is a derivative of NAFION in which the NAFION is partially neutralized with a lithium ion source. In other embodiments, ionomer membrane 108 may comprise another ionomer, as an alternative, or in addition to the NAFION derivative in the ionomer membrane 108. The ionomer membrane 108 is permeable to lithium ions, but functions in the cell 100 as a barrier to limit the passage of soluble sulfur compounds shuttling in the cell solution from reaching the negative electrode 101. Ionomer membrane 108 may also function as a reservoir through adsorption of soluble sulfur compounds from the cell solution or by otherwise limiting their passage through the ionomer membrane 108. However, ionomer membrane 108 permits diffusion of lithium ions to and from the negative electrode 101 during charge or discharge phases in the cell 100.

Ionomer membranes 109 and 112 are lithium transport separators which are fully situated within the cell solution of the cell 100. Ionomer membranes 110 and 111 are lithium transport separators which are situated so one face covers a respective side of the lithium transport separator 105 while an opposing face is exposed to the cell solution of the cell 100. All the ionomer membranes 109-112 are located between the positive electrode 102 and the negative electrode 101, but are located on one side or the other of the lithium transport separator 105 and may be secured within cell 100 by being affixed to another object in the cell 100, such as the cell container wall 107.

Ionomer membrane 113 is a cathodic-lithium transport separator which is affixed or in close proximity to a surface of the positive electrode 102. Ionomer membrane 113 is similar to the ionomer membrane 108 near the electrode 101 and comprises at least some ionomer, such as a halogen ionomer which may be incorporated as in membrane 108. Ionomer membrane 113 is in proximity with the positive electrode 102 which has no highly reactive lithium metal surfaces, so ionomer membrane 113 generally does not include a protective layer as ionomer membrane 108 may near negative electrode 101, according to an embodiment.

All the ionomer membranes 109-113 may, or may not, share the same or similar membrane structural parameters and/or membrane morphologies. However, they all comprise at least some amount of at least one type of ionomer, such as a halogen ionomer. Given any differences in their respective membrane structures and their respective membrane morphologies, they otherwise function similarly in the cell 100 as lithium transport separators, such as described above with respect to the ionomer membrane 108 and/or the ionomer membrane in lithium transport separator 105.

According to the principles of the invention, a Li—S cell, such as cell 100, incorporates at least one ionomer membrane and may incorporate a plurality of ionomer membranes as demonstrated in cell 100, and in various different combinations and configurations. In one embodiment, an ionomer membrane may comprise an ionomer that is a polymeric sulfonate. In another embodiment, an ionomer membrane may comprise an ionomer that is a polymeric carboxylate. In yet another embodiment, an ionomer membrane may comprise an ionomer that is a polymeric phosphate or a polymeric phosphonate. In still another embodiment, an ionomer membrane may comprise an ionomer that is a copolymer including at least two types of ionic functionality. In still yet another embodiment, an ionomer membrane may comprise at least two different types of ionomer with different ionic functionality in the same ionomer and/or in distinct ionomers.

Ionomer membranes suitable for use herein may be described in terms of the thickness of the membranes. The term “thickness” as used herein is synonymous; generally, with the average thickness of a membrane unless otherwise indicated by the context in which it is used. Ionomer membranes suitable for use herein include those having a thickness of about 3 to 500 microns (i.e., μm). Ionomer membranes having a suitable thickness include those having a thickness of about 3 μm, 5 μm, 10 μm, 20 μm, 40 μm, 60 μm, 80 μm, 100 μm, 150 μm, 200 μm, 250 μm, 300 μm, 400 μm, 500 μm and larger thicknesses.

In an embodiment, an ionomer article, such as a membrane or film, may modify another element in a cell, such as a lithium transport separator in a porous separator in an electrolyte medium of the cell. In another embodiment, an ionomer membrane may form a separate element in a cell, which is situated in the cell solution, separate from other elements in the cell. Such an article membrane may float freely in the cell solution or be secured, such as by being affixed to a cell wall. In this circumstance, the ionomer article may be fully or partially situated within the electrolyte medium and may be secured by fastening an edge of the ionomer article to the interior wall of the cell, or by affixing it to another element or part in the cell.

Ionomers suitable for use herein, include ionomers which incorporate pendant negatively charged functional groups which are neutralized. The negatively charged functional groups may be an acid (e.g., carboxylic acid, phosphonic acid and sulfonic acid) or an amide (e.g., acrylamide). The negatively charged functional groups may be neutralized, fully or partially with a metal ion, preferably with an alkali metal which may be ion-exchanged into the ionomer. Lithium is preferred for an ionomer utilized within an IC membrane in a Li—S cell. An ionomer may contain negatively-charged functional groups, exclusively (i.e., anionomers) or may contain a combination of negatively-charged functional groups with some positively-charged functional groups (i.e., ampholytes).

The ionomers may include ionic monomer units copolymerized with nonionic (i.e., electrically neutral) monomer units. The ionic functional groups may be randomly distributed or regularly located in the ionomers. The ionomers can be prepared by polymerization of ionic monomers, such as ethylenically unsaturated carboxylic acid comonomers. Other ionomers suitable for use herein are ionically modified “ionogenic” polymers which may be made by chemical modification of negatively charged functional groups on the ionogenic polymer (i.e., chemical modification after polymerization). These may be made, such as by treatment of a polymer having carboxylic acid functionality which is chemically modified by neutralizing to form ester-containing carboxylate functional groups. The ester-containing carboxylate functional groups are ionized with an alkali metal, thus forming negatively charged ionic functionality.

Ionomers may be polymers including ionic and non-ionic monomeric units in a saturated or unsaturated backbone, optionally including branching, such as carbon-based branching and may include other elements, such as oxygen or silicon. The negatively charged functional groups may be any species capable of forming an ion with an alkali metal. These include, but are not limited to, sulfonic acids, carboxylic acids and phosphonic acids. According to an embodiment, the polymer backbone or branches in an ionomer may include comonomers such as alkyls. Alkyls which are a-olefins are preferred. Suitable a-olefin comonomers include, but are not limited to, ethylene, propylene, 1-butene, 1-pentene, 1-hexene, 1-heptene, 3 methyl-1-butene, 4-methyl-1-pentene, styrene and the like and mixtures of two or more of these α-olefins.

According to an embodiment, an ionomer may be an ionogenic acid copolymer which is neutralized with a base so that the acid groups in the precursor acid copolymer form ester salts, such as carboxylate or sulfonate groups. The precursor acid copolymer groups may be fully neutralized or partially neutralized to a “neutralization ratio” based on the amount neutralized of all the negatively charged functional groups that may be neutralized in the ionomer. According to an embodiment, the neutralization ratio is 0% to about 1%. In other embodiments, the neutralization ratio is about 5%, about 10%, about 20%, about 30%, about 40%, about 50%, about 60%, about 70%, about 80%, about 90%, about 95%, or about 100%.

According to an embodiment, the neutralization ratio is about 0% to 90%. In other embodiments, the neutralization ratio is about 20% to 80%, about 30% to 70%, about 40% to 60% or about 50%.

The neutralization ratio may be selected for different desired properties, such as to promote conductivity in the ionomer, to promote the dispersability of the ionomer in a particular solvent or to promote miscibility with another polymer in a blend. Methods of changing the neutralization ratio include increasing the neutralization, such as by introducing basic ion sources to promote a greater degree of ionization among the monomer units. Methods of changing the neutralization ratio also include those for decreasing neutralization, such as by introducing a highly neutralized ionomer to strong acids to convert some or all of an ionic functionality (e.g., (meth)acrylate) to an acid (e.g., (meth)acrylic acid).

Although any stable cation is believed to be suitable as a counter-ion to the negatively charged functional groups in an ionomer, monovalent cations, such as cations of alkali metals, are preferred. Still more preferably, a base, such as a lithium ion-containing base, is utilized to provide a lithiated ionomer wherein part or all of the precursor groups are replaced by lithium salts. To obtain such ionomers, the precursor polymers may be neutralized, by any conventional procedure, with one or more ion sources. Typical basic ion sources include sodium hydroxide, sodium carbonate, zinc oxide, zinc acetate, magnesium hydroxide, and lithium hydroxide. Other basic ion sources are well known. A lithium ion source is preferred.

Halogen ionomers suitable for use herein are available from various commercial sources or they can be prepared by synthesis using methods well-known in the art. According to an embodiment, particularly useful halogen ionomers include NAFION and variants of NAFION which are derivatives of commercially available forms of NAFION. One NAFION variant may be made by treating a commercially available NAFION with a strong acid to reduce the overall neutralization ratio and to promote its dispersability in aqueous solution. According to another variant, a NAFION is ion-exchanged to increase its lithium ion content.

NAFION is an example of an FSA halogen ionomer. An FSA ionomer is a halogen ionomer which is a “highly-fluorinated” sulfonic acid halogen ionomer. “Highly fluorinated” means that at least about 50% of the total number of halogen and hydrogen atoms in the polymer are replaced by fluorine atoms. In an embodiment, at least about 75% are fluorinated, in another embodiment at least about 90% are fluorinated. In yet another embodiment, the polymer is perfluorinated, which is fully fluorinated or near to fully fluorinated. A sulphonic acid ionomer includes monomer units including a “sulfonate functional group.” The term “sulfonate functional group” in this context refers either to sulfonic acid groups or salts of sulfonic acid groups, and in one embodiment is alkali metal or ammonium salts. The sulfonate functional group is represented by the formula —SO₃X where X is a cation, also known as a “counterion”. X may be H, Li, Na, K or an amine. In one embodiment, X is H, in which case the ionomer is said to be in the “acid form”. X may also be multivalent, as represented by such ions as Ca⁺⁺ and Al⁺⁺⁺. In the case of multivalent counter ions, represented generally as Mⁿ⁺, the number of sulfonate functional groups per counterion is generally equal to the valence “n”.

In an embodiment, the FSA halogen ionomers comprise a polymer backbone with recurring side chains attached to the backbone, the side chains carrying counterion exchange groups. FSA halogen ionomers include homopolymers or copolymers of two or more monomers. Copolymers are typically formed from a nonfunctional first monomer and a second monomer carrying the counterion exchange group or its acid precursor, (e.g., a sulfonyl fluoride group (—SO₂F)), which can be subsequently hydrolyzed to a sulfonate functional group. For example, copolymers of a first fluorinated vinyl monomer copolymerized with a second fluorinated vinyl monomer having a sulfonyl fluoride group (—SO₂F) may be used. Possible first monomers include tetrafluoroethylene (TFE), hexafluoropropylene, vinyl fluoride, vinylidine fluoride, trifluoroethylene, chlorotrifluoroethylene, perfluoro(alkyl vinyl ether), and combinations thereof. TFE is preferred.

In another embodiment, at least one monomer may comprise fluorinated vinyl ether and a sulfonate functional group or precursor group which can provide a desired side chain in the FSA ionomer. Additional monomers, including ethylene, propylene, and R′—CH═CH₂ where R′ is a perfluorinated alkyl group of 1 to 10 carbon atoms, can be incorporated into the FSA halogen ionomer as desired. The FSA halogen ionomer may be of the type referred to as random copolymers. Random copolymers may be made by a polymerization process in which the relative concentrations of the comonomers are kept as constant as desired, so that the distribution of the monomer units along the polymer chain is in accordance with their relative concentrations and relative reactivities. Less random copolymers, such as those made by varying relative concentrations of monomers in the course of the polymerization, may also be used. Polymers of the type called block copolymers, may also be used.

In another embodiment, the FSA halogen ionomers suitable for use herein include a highly fluorinated backbone, including those that are a perfluorinated carbon backbone and side chains represented by the formula —(O—CF₂CFR_{f})_{α}—O—CF₂CFR′_{f}SO₃X in which R_{f} and R′_{f} are independently selected from F, Cl or a perfluorinated alkyl group having 1 to 10 carbon atoms, a being 0, 1 or 2, and X is H, Li, Na, K or an amine that may be the same or different. In one embodiment X is H, CH₃ or C₂H₅. In another embodiment X is H. As stated above, X may also be multivalent.

Useful FSA halogen ionomers include, for example, those disclosed in U.S. Pat. No. 3,282,875 and in U.S. Pat. Nos. 4,358,545 and 4,940,525 which are incorporated by reference herein in there entireties. An example of a preferred FSA halogen ionomer is one including a perfluorocarbon backbone and a side chain represented by the formula —O—CF₂CF(CF₃)—O—CF₂CF₂SO₃X where X is as described above. FSA halogen ionomers of this type are disclosed in U.S. Pat. No. 3,282,875 and can be made by copolymerization of tetrafluoroethylene (TFE) and the perfluorinated vinyl ether CF2═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups. These may be ion exchanged as necessary to convert them to the desired ionic form. An example of a useful FSA halogen ionomer of this type is disclosed in U.S. Pat. Nos. 4,358,545 and 4,940,525 and has the side chain —O—CF₂CF₂SO₃X, wherein X is as described above. This FSA halogen ionomer can be made by copolymerization of tetrafluoroethylene (TFE) and the perfluorinated vinyl ether CF₂═CF—O—CF₂CF₂SO₂F, perfluoro(3-oxa4-pentenesulfonyl fluoride) (POPF), followed by hydrolysis and further ion exchange as necessary.

FSA halogen ionomers which are suitable for use herein generally have an ion exchange ratio of less than about 90, preferably less than 50, and even more preferably less than 33. As used herein, “ion exchange ratio” or “IXR” is defined as number of carbon atoms in the polymer backbone in relation to the counterion exchange groups. Within the range of less than about 33, IXR can be varied as desired. With most FSA halogen ionomers, the IXR is about 3 to about 33, and in another embodiment is about 8 to about 23.

The counterion exchange capacity of a polymer is often expressed in terms of equivalent weight (EW). For the purposes of its use herein, equivalent weight (EW) is the weight of the polymer in acid form required to neutralize one equivalent of sodium hydroxide.

In the case of a sulfonate polymer where the polymer has a perfluorocarbon backbone and the side chain is —O—CF₂—CF(CF₃)—O—CF₂CF₂—SO₃H (or a salt thereof), the equivalent weight range which corresponds to an IXR of about 8 to about 23 is about 750 EW to about 1500 EW. IXR for this polymer can be related to equivalent weight using the formula: 50 IXR+344=EW. While the same IXR range is used for sulfonate polymers disclosed in U.S. Pat. Nos. 4,358,545 and 4,940,525, such as the FSA ionomer having the side chain —O—CF₂—CF(CF₃)—O—CF₂CF₂—SO₃H (or a salt thereof), the equivalent weight is somewhat lower because of the lower molecular weight of the monomer unit containing a counterion exchange group. For the IXR range of about 8 to about 23, the corresponding equivalent weight range is about 575 EW to about 1325 EW. IXR for this FSA ionomer can be related to equivalent weight using the formula: 50 IXR+178=EW.

The synthesis of FSA halogen ionomers is well known. The FSA halogen ionomers can be prepared as colloidal aqueous dispersions. They may also be in the form of dispersions in other media, examples of which include, but are not limited to, alcohol, water-soluble ethers, such as tetrahydrofuran, mixtures of water-soluble ethers, and combinations thereof. U.S. Pat. Nos. 4,433,082 and 6,150,426 disclose methods for making of aqueous alcoholic dispersions. After the dispersion is made, the concentration and the dispersing liquid composition can be adjusted by methods known in the art. Aqueous dispersions of FSA halogen ionomer are available commercially as NAFION dispersions, from E. I. du Pont de Nemours and Company and Sigma-Aldrich.

SURLYN is an example of a hydrocarbon ionomer which is a random copolymer-poly(ethylene-co-(meth)acrylic acid). E.I. du Pont de Nemours and Co., Wilmington, Del., provides the SURLYN resin brand, that generally incorporate a copolymer of ethylene and (meth)acrylic acid. SURLYN is produced through the copolymerization of ethylene and (meth)acrylic acid via a high pressure free radical reaction, similar to that for the production of low density polyethylene and has an incorporation ratio of (meth)acrylic comonomer that is relatively low and is typically less than 20% per mole and often less than 15% per mole of the copolymer. Variants of the SURLYN are disclosed in U.S. Pat. No. 6,518,365 which is incorporated by reference herein in its entirety. According to an embodiment, particularly useful hydrocarbon ionomers include SURLYN and variants of SURLYN which may be are derivatives of commercially available forms of SURLYN. One SURLYN derivative may be made by treating SURLYN with a strong acid to reduce the overall neutralization ratio to promote its dispersability in aqueous solution. According to another variant, SURLYN is ion-exchanged to increase the lithium ion content.

According to an embodiment, a suitable hydrocarbon ionomer includes ethylene-(meth)acrylic acid copolymer having about 5 to 25 wt. % (meth)acrylic acid monomer units based on the weight of the ethylene-(meth)acrylic acid copolymer; and more particularly, the ethylene-(meth)acrylic acid copolymer has a neutralization ratio of 0.40 to about 0.70. Hydrocarbon ionomers suitable for use herein are available from various commercial sources or they can be prepared by synthesis.

An ionomer, such as halogen and/or hydrocarbon ionomer, may be neutralized. Neutralization of the ionomer may be with a neutralization agent that may be represented by the formulas MA where M is a metal ion and A is the co-agent moiety such as an acid or base. Metal ions suitable as the metal ion include monovalent, divalent, trivalent and tetravalent metals. Metal ions suitable for use herein include, but are not limited to, ions of Groups IA, IB, HA, IIB, IIIA, IVA, IVB, VB, VIB, VIIB and VIII metals of the Periodic Table. Examples of such metals include Na⁺, Li⁺, K⁺ and Sn⁴⁺. Li⁺ is preferred for utilization of the ionomer in an IC membrane of a Li—S cell.

Neutralization agents suitable for use herein include any metal moiety which would be sufficiently basic to form a salt with a low molecular weight organic acid, such as benzoic acid or p-toluene sulfonic acid. One suitable neutralization agent is lithium hydroxide distributed by Sigma Aldrich (Sigma Aldrich, 545856). Other neutralization agents and neutralization processes to form ionomers are described in U.S. Pat. No. 5,003,012 which is incorporated by reference herein in its entirety.

Other ionomers which are suitable include block copolymers such as those derived from the sulphonation of polystyrene-b-polybutadiene-b-polystyrene. Sulfonated polysulphones and sulfonated polyether ether ketones are also suitable. Phosphonate ionomers may also be used, as well as copolymers with more than one ionic functionality. For example, direct co-polymerization of dibutyl vinylphosphonate with acrylic acid yields a mixed carboxylate-phosphonate ionomer. Copolymers derived from vinyl phosphonates with styrene, methyl methacrylate, and acrylamide may also be used. Phosphorus containing polymers can also be made after polymerization by phosphonylation reactions, typically with POCl₃. For example, phosphonylation of polyethylene can produce a polyethylene-phosphonic acid copolymer.

Ionomers which are suitable for use herein include carboxylate, sulfonate and phosphonate ionomers. Others are also suitable, such as styrene alkoxide ionomers such as those derived from polystyrene-co-4-methoxy styrene. An ionomer may have a polyvinyl or a polydiene backbone. Different ionomers may differ in properties, partly due to differences in the strength of the ionic interactions and structure. Carboxylate ionomers, sulfonate ionomers, and their mixtures are preferred. Also ionomers in which negatively charged ionic functional groups are neutralized with a lithium ion source to form a salt with lithium are preferred.

Referring again to FIG. 1, depicted is the positive electrode 102, which may be formed to incorporate a cathode composition. The formed positive electrode 102 may be utilized in the cell 100 in conjunction with a negative electrode, such as the lithium-containing negative electrode 101 described above. According to different embodiments, the negative electrode 101 may contain lithium metal or a lithium alloy. In another embodiment, the negative electrode 101 may contain graphite or some other non-lithium material. According to this embodiment, the positive electrode 102 is formed to include some form of lithium, such as lithium sulfide (Li₂S), and according to this embodiment, the C—S composite may be lithiated utilizing lithium sulfide which is incorporated into the powdered carbon to form the C—S composite, instead of elemental sulfur. A lithium transport separator, such as lithium transport separator 105, may be constructed from an ionomer membrane, such as the ionomer membrane described above, or various other materials.

Positive electrode 102, negative electrode 101 and lithium transport separator 105 are in contact with a lithium-containing electrolyte medium in the cell 100, such as a cell solution with solvent and electrolyte. In this embodiment, the lithium-containing electrolyte medium is a liquid. In another embodiment, the lithium-containing electrolyte medium is a solid. In yet another embodiment, the lithium-containing electrolyte medium is a gel.

The negative electrode 101 includes a total amount of electrode lithium which includes an amount electrode lithium which is of electrochemically utilized. The amount of electrochemically utilized electrode lithium may be determined based on the ratio of the charge capacity of the cathode to the anode and it may be quantified in terms of the total weight of electrode lithium in the negative electrode. According to an embodiment, the total amount of the electrochemically utilized electrode lithium is about 1 wt. % or more of the total electrode lithium in negative electrode 101. According to other embodiments, the total amount of the electrochemically utilized electrode lithium is about 2 wt. %, 4 wt. %, 5 wt. %, 10 wt. %, 13 wt. %, 15 wt. %, 20 wt. %, 25 wt. %, 30 wt. %, 35 wt. %, 40 wt. %, 45 wt. %, 50 wt. %, 55 wt. %, 60 wt. % , 65 wt.%, 70 wt.%, 75 wt.%, 80 wt.%, 85 wt.%, 90 wt.%, 95 wt.%, 98 wt.%, 99 wt.%, or 100 wt. % of the total amount of electrode lithium. Ranges among these amounts delineate various embodiments.

Referring again to FIG. 1, depicted is positive electrode 102 in cell 100. The positive electrode 102 may be made by incorporating a cathode composition comprising carbon-sulfur (C—S) composite made from sulfur compound and carbon powder. The cathode composition may also include a polymeric binder, a carbon black and optionally other materials.

A representative carbon powder for making the C—S composite is KETJENBLACK EC-600JD, distributed by Akzo Nobel having an approximate surface area of 1400 m²/g BET (Product Data Sheet for KETJENBLACK EC-600JD, Akzo Nobel) and an approximate pore volume of 4.07 cc/gram, as determined according to the BJH method, based on a cumulative pore volume for pores ranging from 17-3000 angstroms. In the BJH method, nitrogen adsorption/desorption measurements were performed on ASAP model 2400/2405 porosimeters (Micrometrics, Inc., No. 30093-1877). Samples were degassed at 150° C. overnight prior to data collection. Surface area measurements utilized a five-point adsorption isotherm collected over 0.05 to 0.20 p/p₀ and were analyzed via the BET method, described in Brunauer et al., J. Amer. Chem. Soc., v. 60, no. 309 (1938), and incorporated by reference herein in its entirety. Pore volume distributions utilized a 27 point desorption isotherm and were analyzed via the BJH method, described in Barret, et al., J. Amer. Chem. Soc., v. 73, no. 373 (1951), and incorporated by reference herein in its entirety.

Other commercially available carbon powders which may be utilized include KETJEN 300: approximate pore volume 1.08 cc/g (Akzo Nobel) CABOT BLACK PEARLS: approximate pore volume 2.55 cc/g, (Cabot), PRINTEX XE-2B: approximate pore volume 2.08 cc/g (Orion Carbon Blacks, The Cary Company). Other sources of such carbon powders are well-known to those of ordinary skill in the art.

Sulfur compounds which are suitable for making the C—S composite include molecular sulfur in its various allotropic forms and combinations thereof, such as “elemental sulfur.” Elemental sulfur is a common name for a combination of sulfur allotropes including puckered S₈ rings, and often including smaller puckered rings of sulfur. Other sulfur compounds which are suitable are compounds containing sulfur and one or more other elements. These include lithiated sulfur compounds, such as for example, Li₂S or Li₂S₂. A representative sulfur compound is elemental sulfur distributed by Sigma Aldrich as “Sulfur”, (Sigma Aldrich, 84683). Other sources of such sulfur compounds are known to those having ordinary skill in the art.

A polymeric binder which may be utilized for making the cathode composition includes polymers exhibiting chemical resistance, heat resistance as well as binding properties, such as polymers based on alkylenes, oxides and/or fluoropolymers. Examples of these polymers include polyethylene oxide (PEO), polyisobutylene (PIB), and polyvinylidene fluoride (PVDF). A representative polymeric binder is polyethylene oxide (PEO) with an average M_{w} of 600,000 distributed by Sigma Aldrich as “Poly(ethylene oxide)”, (Sigma Aldrich, 182028). Another representative polymeric binder is polyisobutylene (PIB) with an average M_{w} of 4,200,000 distributed by Sigma Aldrich as “Poly(isobutylene)”, (Sigma Aldrich, 181498). Polymeric binders which are suitable for use herein are also described in U.S. Published Patent Application No. U.S. 2010/0068622, which is incorporated by reference herein in its entirety. Other sources of polymeric binders are known to those having ordinary skill in the art.

Carbon blacks which are suitable for making the cathode composition include carbon substances exhibiting electrical conductivity and generally having a lower surface area and lower pore volume relative to the carbon powder described above. Carbon blacks typically are colloidal particles of elemental carbon produced through incomplete combustion or thermal decomposition of gaseous or liquid hydrocarbons under controlled conditions. Other conductive carbons which are also suitable are based on graphite. Suitable carbon blacks include acetylene carbon blacks which are preferred. A representative carbon black is SUPER C65 distributed by Timcal Ltd. and having BET nitrogen surface area of 62 m²/g carbon black measured by ASTM D3037-89. Other commercial sources of carbon black, and methods of manufacturing or synthesizing them, are known to those having ordinary skill in the art.

The C—S composite includes a porous carbon material, such as carbon powder, containing the sulfur compound situated in the carbon microstructure of the porous carbon material. The amount of sulfur compound which may be contained in the C—S composite (i.e., the sulfur loading in terms of the weight percentage of sulfur compound, based on the total weight of the C—S composite, is dependent to an extent on the pore volume of the carbon powder. Accordingly, as the pore volume of the carbon powder increases, higher sulfur loading with more sulfur compound is possible. Thus, a sulfur compound loading of, for example, about 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. % , 65 wt. %, 70 wt. %, 75 wt. %, 80 wt. %, 85 wt. %, 85 wt. %, 90 wt. % or 95 wt. % may be used. Ranges among these amounts delineate various embodiments.

The cathode composition may include various weight percentages of C—S composite. The cathode composition may optionally include polymeric binder and carbon black in addition to the C—S composite. The C—S composite is generally present in the cathode composition in an amount which is greater than 50 wt. % of the remainder of the cathode composition. Higher loading with more C—S composite is possible. Thus, a C—S composite loading of, for example, about 55 wt. %, 60 wt. %, 65 wt. %, 70 wt. %, 75 wt. %, 80 wt. %, 85 wt.%, 90 wt.%, 95 wt.%, 98 wt.%, or 99 wt.% may be used. According to an embodiment, about 50 to 99 wt. % C—S composite may be used. In another embodiment, about 70 to 95 wt. % C—S composite may be used.

Polymeric binder may be present in the cathode composition in an amount which is greater than 1 wt. %. Higher loading with more polymeric binder is possible. Thus, a polymeric binder loading of, for example, about 2 wt. %, 3 wt. %, 4 wt. %, 5 wt. %, 6 wt. %, 7 wt. %, 8 wt. %, 9 wt. %, 10 wt. %, 12 wt. %, 14 wt. %, 16 wt. %, or 17.5 wt. % may be used. According to an embodiment, about 1 to 17.5 wt. % polymeric binder may be used. In another embodiment, about 1 to 12 wt. % polymeric binder may be used. In another embodiment, about 1 to 9 wt. % polymeric binder may be used.

The C—S composite may made by various methods, including simply mixing, such as by dry grinding, the carbon powder with the sulfur compound. C—S composite may also be made by introducing the sulfur compound into the microstructure of the carbon powder utilizing such vehicles as heat, pressure, liquid (e.g., a dissolution of sulfur compound in carbon disulfide and impregnation by contacting the solution with the carbon powder), etc.

Useful methods for introducing sulfur compound into the carbon powder include melt imbibement and vapor imbibement. These are compositing processes. Other processes may be used for introducing the sulfur compound into the microstructure of the carbon powder utilizing such vehicles as heat, pressure, liquid, etc.

In melt imbibement, a sulfur compound, such as elemental sulfur can be heated above its melting point (about 113° C.) while in contact with the carbon powder to impregnate it. The impregnation may be accomplished through a direct process, such as a melt imbibement of elemental sulfur, at a raised temperature, by contacting the sulfur compound and carbon at a temperature above 100° C., such as 160° C. A useful temperature range is 120° C. to 170° C.

Another imbibement process which may be used for making the C—S composite is a vapor imbibement which involves the deposition of sulfur vapor. The sulfur compound may be raised to a temperature above 200° C., such as 300° C. At this temperature, the sulfur compound is vaporized and placed in proximity to, but not necessarily in direct contact with, the carbon powder.

These processes may be combined. For example, melt imbibement process can be followed by a higher temperature process. Alternatively, the sulfur compound can be dissolved in carbon disulfide to form a solution and the C—S composite can be formed by contacting this solution with the carbon powder. Sulfur compound may also be introduced to the carbon powder by other methods. For example, sodium sulfide (Na₂S) can be dissolved in an aqueous solution to form sodium polysulfide. The sodium polysulfide can be acidified to precipitate the sulfur compound in the carbon powder. In this process, the C—S composite may require thorough washing(s) to remove salt byproducts.

According to an embodiment, a C—S composite formed by a compositing process may be combined with polymeric binder and carbon black by conventional mixing or grinding processes. A solvent, preferably an organic solvent, such as toluene, alcohol, or n-methylpyrrolidone (NMP) may optionally be utilized. The solvent should preferably not react with the polymeric binder, if any. Conventional mixing and grinding processes are known to those having ordinary skill in the art. The ground or mixed components may form a composition, according to an embodiment, which may be processed and/or formed into an electrode.

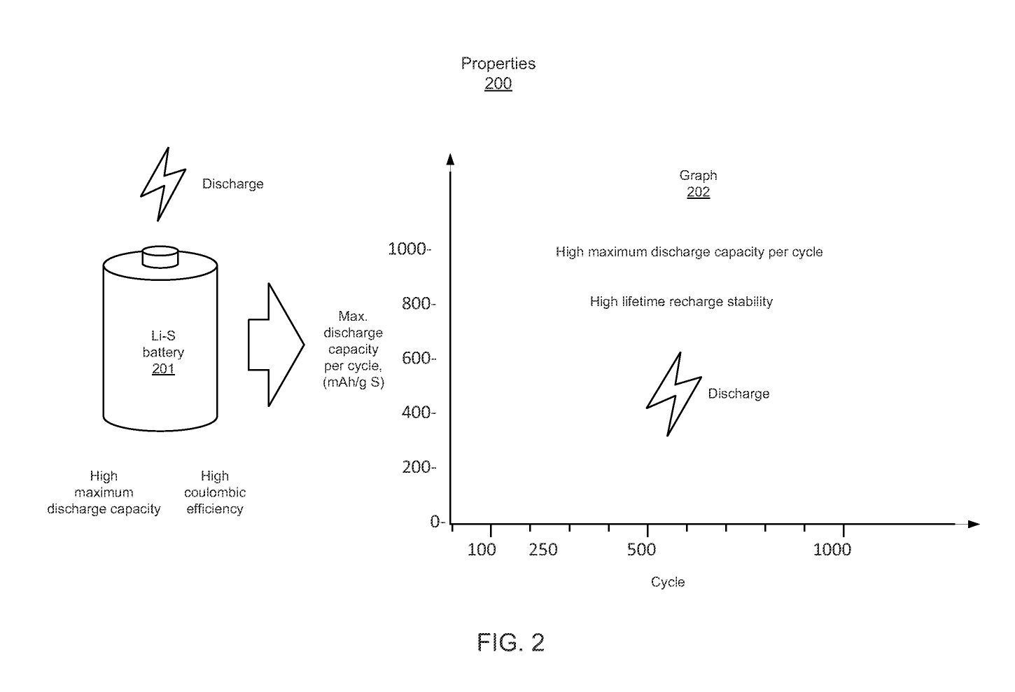

Referring to FIG. 2, depicted is a context diagram illustrating properties 200 of a Li—S battery 201 including a Li—S cell, such as the cell 100 described above, having a positive electrode including sulfur, such as positive electrode 102, an ionomer membrane in a separator, such as lithium transport separator 105, and one or more additives present in the electrolyte medium of the cell. The context diagram of FIG. 2 demonstrate the properties 200 of the Li—S battery 201. The properties 200 include high coulombic efficiency and high maximum discharge capacity associated with battery 201. The high coulombic efficiency appears to be directly attributable to the presence of the ionomer membrane and the additives in the Li—S cell of Li—S battery 201. FIG. 2 also depicts graph 202. The graph 202 demonstrates the maximum discharge capacity per cycle of battery 201 with respect to a number of charge-discharge cycles. The battery 201 also exhibits high lifetime recharge stability and a high maximum discharge capacity per charge-discharge cycle. All these properties 200 of the Li—S battery 201 are demonstrated in greater detail below through the detailed examples.

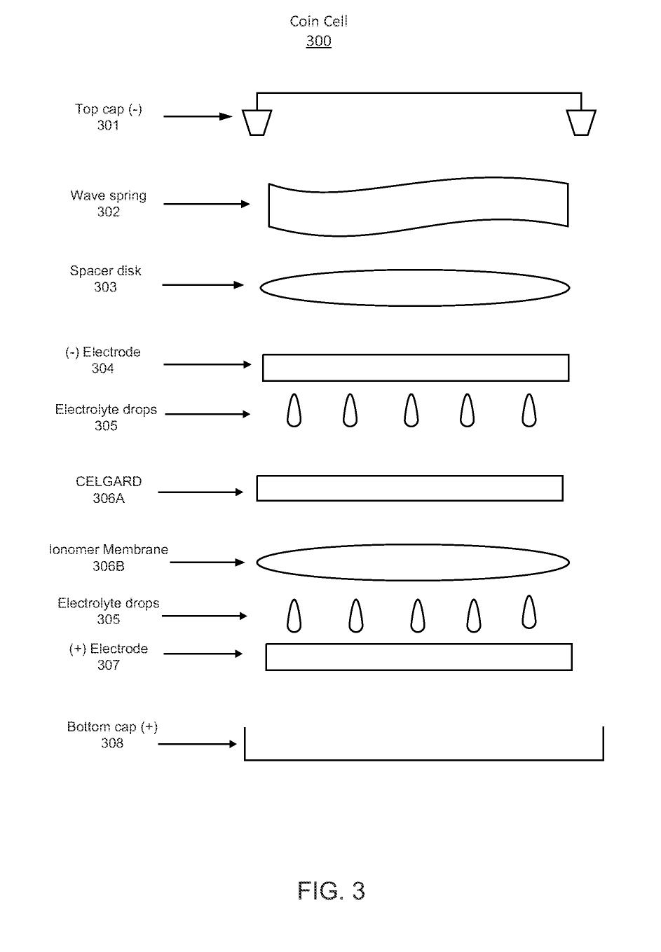

Referring to FIG. 3, depicted is a coin cell 300 which is operable as an electrochemical measuring device for testing various configurations and types of IC membranes. The function and structure of the coin cell 300 are analogous to those of the cell 300 depicted in FIG. 3. The coin cell 300, like the cell 100, utilizes a lithium-containing electrolyte medium comprising one or more additives. The lithium-containing electrolyte medium is in contact with the negative electrode and the positive electrode and may be a liquid containing solvent with a lithium ion electrolyte.

The lithium ion electrolyte may be non-carbon-containing For example, the lithium ion electrolyte may be a lithium salt of such counter ions as hexachlorophosphate (PF₆), perchlorate, chlorate, chlorite, perbromate, bromate, bromite, periodiate, iodate, aluminum fluorides (e.g., AlF₄⁻), aluminum chlorides (e.g. Al₂Cl₇⁻, and AlCl₄⁻), aluminum bromides (e.g., AlBr₄⁻), nitrate, nitrite, sulfate, sulfites, permanganate, ruthenate, perruthenate and the polyoxometallates.

In another embodiment, the lithium ion electrolyte may be carbon containing For example, the lithium ion salt may contain organic counter ions such as carbonate, the carboxylates (e.g., formate, acetate, propionate, butyrate, valerate, lactacte, pyruvate, oxalate, malonate, glutarate, adipate, deconoate and the like), the sulfonates (e.g., CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as the fluorosulfonates (e.g., CF₃SO₃⁻, CF₃CF₂SO₃⁻, CF₃(CF₂)₂SO₃⁻, CHF₂CF₂SO₃⁻ and the like), the fluoroalkoxides (e.g., CF₃O—, CF₃CH₂O⁻, CF₃CF₂O⁻ and pentafluorophenolate), the fluoro carboxylates (e.g. trifluoroacetate and pentafluoropropionate) and fluorosulfonimides (e.g., (CF₃SO₂)₂N⁻). Other electrolytes which are suitable for use herein are disclosed in U.S. Published Patent Applications 2010/0035162 and 2011/00052998, both of which are incorporated herein by reference in their entireties.

The electrolyte medium may generally exclude a protic solvent, since protic liquids are generally reactive with the lithium anode. Solvents are preferable which may dissolve the electrolyte salt. For instance, the solvent may include an organic solvent such as polycarbonate, an ether or mixtures thereof. In other embodiments, the electrolyte medium may include a non-polar liquid. Some examples of non-polar liquids include the liquid hydrocarbons, such as pentane, hexane and the like. According to various embodiments, the nonaqueous solvent may include one or more from the group consisting of acyclic ethers, cyclic ethers, polyethers, cyclic acetals, acyclic acetals and sulfones.

Electrolyte preparations suitable for use in the cell solution may include one or more electrolyte salts in a nonaqueous electrolyte composition. Suitable electrolyte salts include without limitation: lithium hexafluorophosphate, Li PF₃(CF₂CF₃)₃, lithium bis(trifluoromethanesulfonyl)imide, lithium bis (perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris (trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts can also be used. In one embodiment, the electrolyte salt is lithium bis(trifluoromethanesulfonyl)imide). The electrolyte salt may be present in the nonaqueous electrolyte composition in an amount of about 0.2 to about 2.0 M, more particularly about 0.3 to about 1.5 M, and more particularly about 0.5 to about 1.2 M.

### EXAMPLES

The following example demonstrates the preparation and electrochemical evaluation of Li—S cells with additive in the electrolyte medium and incorporating a halogen ionomer membrane which is a lithium exchanged derivative of a NAFION membrane. A comparative example demonstrates a similar Li—S cell without additive in the electrolyte medium. Reference is made to the specific examples below.

Example 1 describes the preparation and electrochemical evaluation of a Li—S cell incorporating a halogen ionomer membrane which is a lithium exchanged derivative of a NAFION membrane. The electrolyte contains 0.1 M LiNO3. The lithium anode metal loading is 2.17 mg, which is equivalent to 8.38 mAh using a value of 3,861 mAh/g for lithium.

Preparation of C—S composite: Approximately 1.0 g of carbon powder (KETJENBLACK EC-600JD, Akzo Nobel) having a surface area of approximately 1,400 m2/g BET (Product Data Sheet for KETJENBLACK EC-600JD, Akzo Nobel) and a pore volume of 4.07 cc/g (as measured by the BJH method) was placed in a 30 ml glass vial and loaded into an autoclave which was charged with approximately 100 grams of elemental sulfur (Sigma Aldrich 84683). The carbon powder was prevented from being in physical contact with the elemental sulfur but the carbon powder had access to sulfur vapor. The autoclave was closed, purged with nitrogen, and then heated to 340° C. for 24 hours under a static atmosphere to develop sulfur vapor. The final sulfur content of the C—S composite was 53.3 wt. % sulfur.

Jar milling of C-S composite: 3.61 g of the C—S composite described above, 103.82 g of toluene (EMD Chemicals) and 230 g of 5 mm diameter zirconia media were weighed evenly between two 125 mL polyethylene bottles, so that each bottle contained equal amounts of each component. The bottles were sealed, and tumbled end-over-end inside a larger jar on jar mill for 15 hours.

Preparation of (80/12/8) electrode composition (C—S composite/binder/carbon black formulation): Polyisobutylene with average Mw of 4,200,000 (Sigma Aldrich 1814980 was dissolved in toluene to produce a 2.0 wt. % polymer solution. 290 mg of conductive carbon black SUPER C65 (Timcal Ltd.) (BET nitrogen surface area of 62 m²/g measured by ASTM D3037-89) (Technical Data Sheet for SUPER C65, Timcal Ltd.) was dispersed in 21.65 g of the 2.0 wt. % PIB solution along with 21 g of toluene. The slurry was mixed with a magnetic stir bar for 5 minutes to form a SUPER C65/PIB slurry. 86.4 g of the jar milled suspension of C-S composite described above was added to the SUPER C65/PIB slurry along with an additional 44 g of toluene. This ink, with a 2.10 wt. % solid loading, was stirred for 3 hours.

Spray coating to form layering/electrode: A layering/electrode was formed by spraying a portion of the formulated ink slurry mixture onto one side of double-sided carbon coated aluminum foil (1 mil, Exopac Advanced Coatings) as a substrate for the layering/electrode. The dimensions of the coated area on the substrate were approximately 11 cm×11 cm. The ink slurry mixture was sprayed through an air brush (PATRIOT 105, Badger Air-Brush Co.) onto the substrate in a layer by layer pattern. The substrate was heated on a 70° C. hotplate for about 10 seconds following the application of every 4 layers to the substrate surface. Once all of the ink slurry mixture was sprayed onto the substrate, the layering/electrode was placed in a vacuum at a temperature of 70° C. for a period of 5 minutes. The dried layering/electrode was calendared between two steel rollers on a custom built device to a final thickness of about 1 mil.

Preparation of Lithium ion exchanged halogen ionomer (NAFION) membrane: A 2 mil thick NAFION membrane (DuPont NR211, Wilmington, Del.), in the proton form was exchanged with lithium by soaking in a 1 M aqueous lithium hydroxide solution for 12 hours, followed by rinsing with copious amounts of deionized water. The exchanged membrane was dried at 110° C. for 2 hours, then 150° C. for 4 hours in a vacuum oven, before being transferred into a nitrogen dry box. Inside the dry box, the membrane was punched to form a 16 mm diameter disk. This disk was soaked in dimethoxyethane (Sigma Aldrich 259527) at 25 C. for approximately 16 hours to swell the membrane.

Drying of Lithium Nitrate Powder: 1 g of Lithium nitrate powder (Sigma Aldrich, 229741) was placed in a glass vial and heated to 240° C. under vacuum for 6 hours. It was subsequently transferred, at ˜120 C. directly to a nitrogen dry box.

Preparation of electrolyte: In a 40 ml glass vial, 3.59 grams of lithium bis(trifluoro- methane sulfonyl)imide (LiTFSI, Novolyte) was combined with 20.24 grams of 1,2 dimethoxyethane (glyme, Sigma Aldrich, 259527) and 0.172 g dried lithium nitrate to create an electrolyte solution containing 0.1 M Lithium nitrate and 0.5 M of the LiTFSI in glyme.

Preparation of coin cell: A 14.29 mm diameter circular disk was punched from the layering/electrode and used as the positive electrode 307. The final weight of the electrode (14.29 mm in diameter, subtracting the weight of the aluminum current collector) was 4.50 mg. This corresponds to a calculated weight of 1.92 mg of elemental sulfur on the electrode.

The coin cell 300 included the positive electrode 307, the 19 mm diameter circular disk punched from the lithium exchanged NAFION membrane 306B described in the previous section and a 19 mm piece 306A of CELGARD 2500 polyolefin separator (Celgard, LLC). The two disks (306A and 306B) were used together as the lithium transport separator in the coin cell 300 with the lithium exchanged NAFION membrane 306B next to the side of the CELGARD separator 306A facing the positive electrode 307.

The positive electrode 307, the lithium transport separator (306A and 306B), a lithium foil negative electrode 304 (2 mils thickness, Chemetall Foote Corp., punched to 11.36 mm diameter) and a few electrolyte drops 305 of the nonaqueous electrolyte was sandwiched in a HOHSEN 2032 stainless steel coin cell can with a 1 mil thick stainless steel spacer disk 303 and wave spring 302 (Hohsen Corp.). The construction involved the following sequence as shown in FIG. 3: bottom cap 308, positive electrode 307, electrolyte drops 305, lithium transport separator (306A and 306B), electrolyte drops 305, negative electrode 304, spacer disk 303, wave spring 302 and top cap 301. The final assembly was crimped with an MTI crimper (MTI).

Electrochemical testing conditions: The positive electrode 307 was cycled at room temperature between 1.5 and 3.0 V (vs. Li/Li⁰) at C/5 (based on 1675 mAh/g S for the charge capacity of elemental sulfur). This is equivalent to a current of 335 mAh/g S in the positive electrode 307.

Electrochemical evaluation: The maximum charge capacity measured on discharge at cycle 20 was 710 mAh/g S with a coulombic efficiency of 99.4%.

Comparative Example A: Comparative example A describes the preparation and electrochemical evaluation of a Li—S cell incorporating a halogen ionomer membrane which is a lithium exchanged derivative of a NAFION membrane. The electrolyte does not contain the lithium nitrate additive. The lithium anode metal loading is 2.17 mg, which is equivalent to 8.38 mAh using a value of 3,861 mAh/g for lithium.

Preparation of C—S composite: Approximately 1.0 g of carbon powder (KETJENBLACK EC-600JD, Akzo Nobel) having a surface area of approximately 1400 m2/g BET (Product Data Sheet for KETJENBLACK EC-600JD, Akzo Nobel) and a pore volume of 4.07 cc/g (as measured by the BJH method) was placed in a 30 ml glass vial and loaded into an autoclave which was charged with approximately 100 grams of elemental sulfur (Sigma Aldrich 84683). The carbon powder was prevented from being in physical contact with the elemental sulfur but the carbon powder had access to sulfur vapor. The autoclave was closed, purged with nitrogen, and then heated to 340° C. for 24 hours under a static atmosphere to develop sulfur vapor. The final sulfur content of the C—S composite was 53.3 wt. % sulfur.

Jar milling of C-S composite: 3.61 g of the C—S composite described above, 103.82 g of toluene (EMD Chemicals) and 230 g of 5 mm diameter zirconia media were weighed evenly between two 125 mL polyethylene bottles, so that each bottle contained equal amounts of each component. The bottles were sealed, and tumbled end-over-end inside a larger jar on jar mill for 15 hours.

Preparation of (80/12/8) electrode composition (C—S composite/binder/carbon black formulation): Polyisobutylene with average Mw of 4,200,000 (Sigma Aldrich 1814980 was dissolved in toluene to produce a 2.0 wt. % polymer solution. 290 mg of conductive carbon black SUPER C65 (Timcal Ltd.) (BET nitrogen surface area of 62 m²/g measured by ASTM D3037-89) (Technical Data Sheet for SUPER C65, Timcal Ltd.) was dispersed in 21.65 g of the 2.0 wt. % PIB solution along with 21 g of toluene. The slurry was mixed with a magnetic stir bar for 5 minutes to form a SUPER C65/PIB slurry. 86.4 g of the jar milled suspension of C-S composite described above was added to the SUPER C65/PIB slurry along with an additional 44 g of toluene. This ink, with a 2.10 wt. % solid loading, was stirred for 3 hours.

Spray coating to form layering/electrode: A layering/electrode was formed by spraying a portion of the formulated ink slurry mixture onto one side of double-sided carbon coated aluminum foil (1 mil, Exopac Advanced Coatings) as a substrate for the layering/electrode. The dimensions of the coated area on the substrate was approximately 11 cm×11 cm. The ink slurry mixture was sprayed through an air brush (PATRIOT 105, Badger Air-Brush Co.) onto the substrate in a layer by layer pattern. The substrate was heated on a 70° C. hotplate for about 10 seconds following the application of every 4 layers to the substrate surface. Once all of the ink slurry mixture was sprayed onto the substrate, the layering/electrode was placed in a vacuum at a temperature of 70° C. for a period of 5 minutes. The dried layering/electrode was calendared between two steel rollers on a custom built device to a final thickness of about 1 mil.

Preparation of Lithium ion exchanged halogen ionomer (NAFION) membrane: A 2 mil thick NAFION membrane (DuPont NR211, Wilmington, Del.), in the proton form was exchanged with lithium by soaking in a 1 M aqueous lithium hydroxide solution for 12 hours, followed by rinsing with copious amounts of deionized water. The exchanged membrane was dried at 110° C. for 2 hours, then 150° C. for 4 hours in a vacuum oven, before being transferred into a nitrogen dry box. Inside the dry box, the membrane was punched to form a 16 mm diameter disk. This disk was soaked in dimethoxyethane (Sigma Aldrich 259527)for 16 hours to swell the membrane.

Preparation of electrolyte: 3.79 grams of lithium bis(trifluoromethanesulfonyl)imide (LiTFSI, Novolyte, Cleveland, Ohio) was combined with 1,2 dimethoxyethane (glyme, Sigma Aldrich, 259527) in a 25 mL volumetric flask to create a 0.5 M electrolyte solution.

Preparation of coin cell: A 14.29 mm diameter circular disk was punched from the layering/electrode and used as the positive electrode. The final weight of the electrode (14.29 mm in diameter, subtracting the weight of the aluminum current collector) was 4.50 mg. This corresponds to a calculated weight of 1.92 mg of elemental sulfur on the electrode.

The coin cell included the positive electrode, the 19 mm diameter circular disk punched from the lithium exchanged NAFION membrane described in the previous section and a 19 mm piece of CELGARD 2300 polyolefin separator (Celgard, LLC). The two disks were used together as the lithium transport separator in the coin cell with the lithium exchanged NAFION membrane next to the side of the separator facing the positive electrode.

The positive electrode, the lithium transport separator, a lithium foil negative electrode (2 mils thickness, Chemetall Foote Corp., punched to a diameter of 11.36 mm) and a few electrolyte drops of the nonaqueous electrolyte was sandwiched in a HOHSEN 2032 stainless steel coin cell can with a 1 mil thick stainless steel spacer disk and wave spring (Hohsen Corp.). The construction involved the following sequence as shown in FIG. 3: bottom cap 308, positive electrode 307, electrolyte drops 305, lithium transport separator (306A and 306B), electrolyte drops 305, negative electrode 304, spacer disk 303, wave spring 302 and top cap 301. The final assembly was crimped with an MTI crimper (MTI).

Electrochemical testing conditions: The positive electrode was cycled at room temperature between 1.5 and 3.0 V (vs. Li/LiO) at C/5 (based on 1675 mAh/g S for the charge capacity of elemental sulfur). This is equivalent to a current of 335 mAh/g S in the positive electrode.

Electrochemical evaluation: The maximum charge capacity measured on discharge at cycle 20 was 465 mAh/g S with a coulombic efficiency of 97.5%.

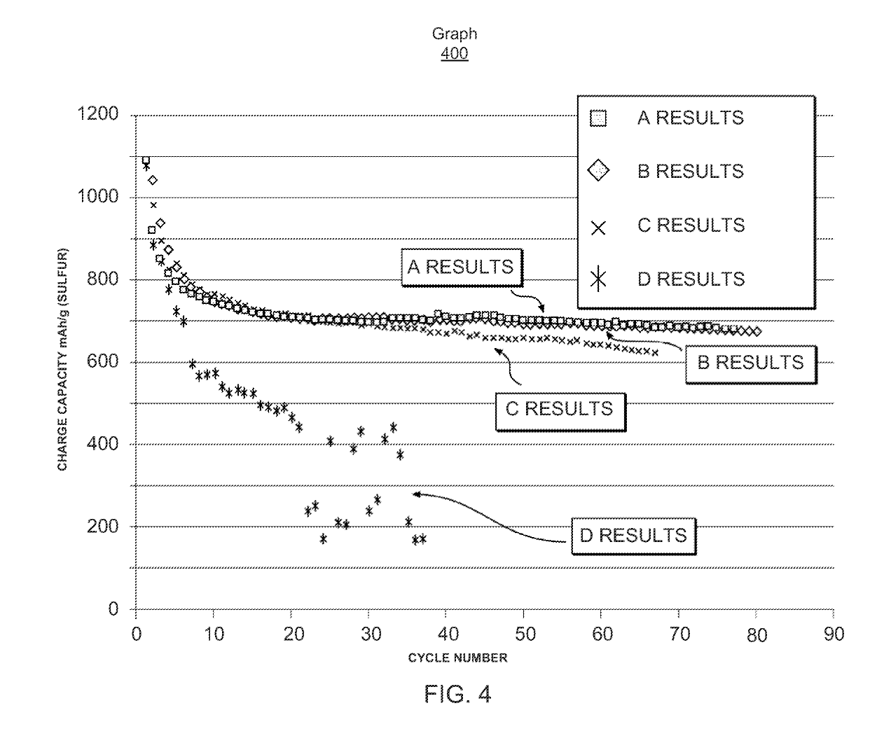

Referring to FIG. 4, depicted is a graph 400 with data demonstrating the surprising and unexpected improvement in the proportion of total electrode lithium which may be utilized electrochemically when an additive, according to the principles of the invention is utilized in a Li—S cell with an ionomer article. The A and B results demonstrate a baseline proportion of electrode lithium that is electrochemically utilized, with (Result A) and without (Result B) an additive.

The cells utilized to generate the C and D results had one third the lithium metal loading as the cells utilized to generate the A and B results. While the C results were run with one third the lithium metal loading and included an additive in the electrolyte medium, the Results C had equivalent charge capacity measures for cycle numbers out to cycle number 70 when compared with the cells utilized to generate the A and B results.

Result A shows the data generated in a Li—S cell with 0.1 M LiNO₃ additive in the electrolyte medium and a NAFION membrane in the lithium transport separator, cycled with a 24 mAh anode. Result B shows the data generated in similar a Li—S cell with no additive in a cell with an equivalent amount of lithium metal in the anode as the cell of Result A. The charge capacity measured at the cycle numbers tested through cycle 70 are nearly identical. Thus the impact of adding the additive to a cell with this amount of electrode lithium in the anode was minimal.

Result C shows the data generated in the Li—S cell of Example 1 described above. The cell generating the Results C has an electrolyte medium with 0.1 M LiNO₃ additive in the electrolyte medium and a NAFION membrane in the lithium transport separator. The cell was cycled with a 8.38 mAh anode.

Result D shows the data generated in the Li—S cell of Comparative Example 1 described above, a Li—S cell similar to Example 1, but with no additive. Note that the Results D demonstrate a significant drop in the charge capacity per cycle almost immediately after the first cycle. This demonstrates the surprising and unexpected improvement in the lesser amount of electrode lithium required to operate the cell while still maintaining charge capacity to higher cycle numbers, and a greater proportion of total electrode lithium which is utilized electrochemically in a cell of this type when an additive, according to the principles of the invention is utilized in a Li—S cell with an ionomer article.

Utilizing a Li—S cell incorporating one or more ionomer articles with an additive in the electrolyte medium provides a high maximum charge capacity Li—S battery with high coulombic efficiency. Li—S cells incorporating ionomer article(s) and additive may be utilized in a broad range of Li—S battery applications for providing a source of potential power for many household and industrial applications. The Li—S batteries incorporating article(s) and additive are especially useful as power sources for small electrical devices such as cellular phones, cameras and portable computing devices and may also be used as power sources for car ignition batteries and for electrified cars.

Although described specifically throughout the entirety of the disclosure, the representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the principles of the invention. While the examples have been described with reference to the figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant art who are not familiar with patent or legal terms or phraseology, to determine quickly from a cursory inspection the nature and essence of this technical disclosure. The Abstract is not intended to be limiting as to the scope of the present invention in any way.

1. A cell, comprising:
a sulfur-containing first electrode;
a lithium-containing second electrode associated with a total amount of electrode lithium, including electrochemically utilized electrode lithium;
a circuit coupling the first electrode with the second electrode;
an article comprising an ionomer; and
an electrolyte medium comprising at least one additive selected from one or more of the groups consisting of
nitrogen-containing additives,
sulfur-containing additives, and
organic peroxide additives.

2. The cell of claim 1, wherein a total amount of the electrochemically utilized electrode lithium is about 4 to 99 wt. % of the total amount of electrode lithium.

3-5. (canceled)

6. The cell of claim 1, wherein the additive contains a Group 1 or Group 2 metal.

7. (canceled)

8. The cell of claim 1, wherein the additive is a nitrogen-containing additive selected from one or more of the groups consisting of inorganic nitrates, organic nitrates, inorganic nitrites, organic nitrites, organic nitro compounds, inorganic nitro-compounds, nitramines, isonitramines, nitramids, organic and inorganic nitroso-compounds, salts of nitronium and nitrosonium, nitrone salts and esters, N-oxides, nitrolic acid salts and esters, hydroxylamine and hydroxylamine derivatives.

9-11. (canceled)

12. The cell of claim 1, wherein the additive is a sulfur-containing additive selected from one or more of the groups consisting of sulfites, persulfates and hyposulfites.

13. (canceled)

14. The cell of claim 1, wherein the additive is a organic peroxide additive selected from one or more of the groups consisting of alkyl hydroperoxides, dialkyl peroxides, peroxycarboxylic acids, diacyl peroxides, peroxycarboxylic esters and peroxycarbonated esters.

15. (canceled)

16. The cell of claim 1, wherein a concentration of the at least one additive in the electrolyte medium is from about 0.0001 to 5 M.

17-18. (canceled)

19. The cell of claim 1, wherein the electrolyte medium comprises at least one nonaqueous solvent.

20. (canceled)

21. The cell of claim 1, wherein the first electrode is a positive electrode and the second electrode is a negative electrode.

22. (canceled)

23. The cell of claim 1, wherein the ionomer is a halogen ionomer.

24. (canceled)

25. The cell of claim 1, wherein the ionomer is a hydrocarbon ionomer.

26. (canceled)

27. The cell of claim 25, wherein the hydrocarbon ionomer is at least partially neutralized.

28. (canceled)

29. A method for making a cell, comprising:
providing an article comprising an ionomer; and
fabricating the cell by combining the article with other components to form the cell, the other components including
a sulfur-containing first electrode,
a lithium-containing second electrode,
a circuit coupling the first electrode with the second electrode, and
an electrolyte medium comprising at least one additive selected from one or more of the groups consisting of
nitrogen-containing additives,
sulfur-containing additives, and
organic peroxide additives.

30. A method for using a cell, comprising at least one step from the plurality of steps comprising
converting chemical energy stored in the cell into electrical energy; and
converting electrical energy into chemical energy stored in the cell, wherein the cell comprises
a sulfur-containing first electrode,
a lithium-containing second electrode associated with a total amount of electrode lithium, including electrochemically utilized electrode lithium,
a circuit coupling the first electrode and the second electrode,
an article comprising an ionomer, and
an electrolyte medium comprising at least one additive selected from one or more of the groups consisting of
nitrogen-containing additives,
sulfur-containing additives, and
organic peroxide additives.

31. The method of claim 30, wherein the cell is associated with at least one of a portable battery, a power source for an electrified vehicle, a power source for an ignition system of a vehicle and a power source for a mobile device.
